(19) United States
(12) Patent Application Publication
(10) Pub. No.: US 2003/0053225 A1
(43) Pub. Date: Mar. 20, 2003

(54) Afocal lens system

(76) Inventor: James A. Mathis, Goad Socorro, NM (US)

Correspondence Address: EASTMAN & ASSOCIATES, Suite 306, 520 West Ash Street, San Diego, CA, 92101, US

(21) Appl. No.: 09/960,273

(22) Filed: Sep. 20, 2001

(51) Int. Cl. G02B 3/02; G02B 13/18; G02B 9/00

(52) U.S. Cl. 359/796

(57) ABSTRACT

An afocal lens system consists of a first convex/concave lens bonded to a second convex/concave lens, forming a doublet. An incident collimated beam of light will be reduced by a magnification factor upon exiting the afocal lens system as a collimated beam of light. Applications for the present invention include, but are not limited to, serving as an interface between a ferrule array with 1.015-mm center-to-center spacing and a MEMS device with 0.9-mm center-to-center spacing assuming a magnification factor of 1.128 of the afocal lens system.

### FIELD OF THE INVENTION

The present invention relates generally to optical lens systems. More specifically, the present invention pertains to an afocal lens system having two convex/concave lenses forming a doublet.

### BACKGROUND OF THE INVENTION

Currently, the demand for increased bandwidth in the world of optical networking seems insatiable. Consequently, many companies are competing to develop new technologies, such as micro-electromechanical systems (MEMS), in order to produce all optical networking systems having the increased bandwidth that will meet the future demands of society. However, as more and more devices are made commercially available, interfacing the different components into a fully functional optical system is becoming increasingly difficult. Additionally, in an all-optical networking system, optimization of the parameters for one component in the system may not match the parameters necessary for optimal performance in another component in the system.

More specifically, current optical switching techniques using MEMS require a precise alignment of the optical fibers into an array. Currently, an effective means to generate this array is by placing the fiber ends into a ferrule array. A ferrule array must conform to specific dimensions in order to be cost-effective and functional, thus resulting in an array of specific dimensions. Some MEMS devices require a light source array of slightly different dimensions than provided by the ferrule array.

Therefore, there is a need for a device that may interface two such dissimilarly configured components within an optical networking system. Additionally, in order to maintain a high system efficiency, the device should not require conversion of the optical signal to an electrical signal in order to interface the two components.

### SUMMARY OF THE PRESENT INVENTION

The proposed afocal lens system receives collimated light from a fiber optic light source and produces collimated light at a different magnification, and includes two convex/concave lenses bonded together to form a doublet lens system. Unlike conventional magnification lens systems, the afocal lens system contains no air-gap. Additionally, the concave radius of curvature of the first convex/concave lens must equal the convex radius of curvature of the second convex/concave lens. Transparent cement is applied between the two mating surfaces of the lenses to ensure a proper bond.

Due to the selection of lens material, the curvature of the lenses, and the thickness of the lenses, distortion, wavefront error, and chromatic aberrations are all very small.

In a preferred embodiment of the present invention, the afocal lens system has a 1.128 times magnification factor. In order to obtain this specific magnification factor, the first lens is made from glass LAKN22 with a center thickness of 3.20-mm, having a convex surface radius of curvature of 18.612-mm and a concave surface radius of curvature of 20.33-mm. The second lens is made from glass SFL6 with a center thickness of 2.00-mm, having a convex radius of curvature of 20.33-mm and a concave surface radius of curvature of 16.955-mm.

With the aforementioned specifications, an array of collimated light sources striking the aperture of the first lens will be reduced by a magnification factor of 1.128 and remain as collimated light. Application of the afocal lens system of this embodiment consists of receiving an array of collimated light sources from a ferrule array device having a separation distance of 1.015-mm from fiber to fiber, and reducing this array of collimated light sources by a factor of 1.128 so that the light sources may enter a MEMS switch with 0.9-mm center-to-center spacing.

### DESCRIPTION OF THE DRAWINGS

The novel features of this invention, as well as the invention itself, both as to its structure and its operation, will be best understood from the accompanying drawings, taken in conjunction with the accompanying description, in which like reference characters refer to similar parts, and in which:

FIG. 1 is an isometric view of the afocal lens system of the present invention and shows a first convex/concave lens bonded to a second convex/concave lens and further shows a ferrule array and a lenslet array emitting collimated light originating from a fiber optic array;

FIG. 2 is a side view of the afocal lens system of the present invention and shows the radii of curvature for the two lenses with respect to a center optical axis;

FIG. 3 is a side view of the afocal lens system of the present invention and shows a ray trace of collimated light; and

FIG. 4 is an end view of the afocal lens system of the present invention along the line 4-4 in FIG. 3, and shows the aperture of afocal lens system coupled with an output image array of collimated light beams.

### DETAILED DESCRIPTION OF A PREFERRED EMBODIMENT

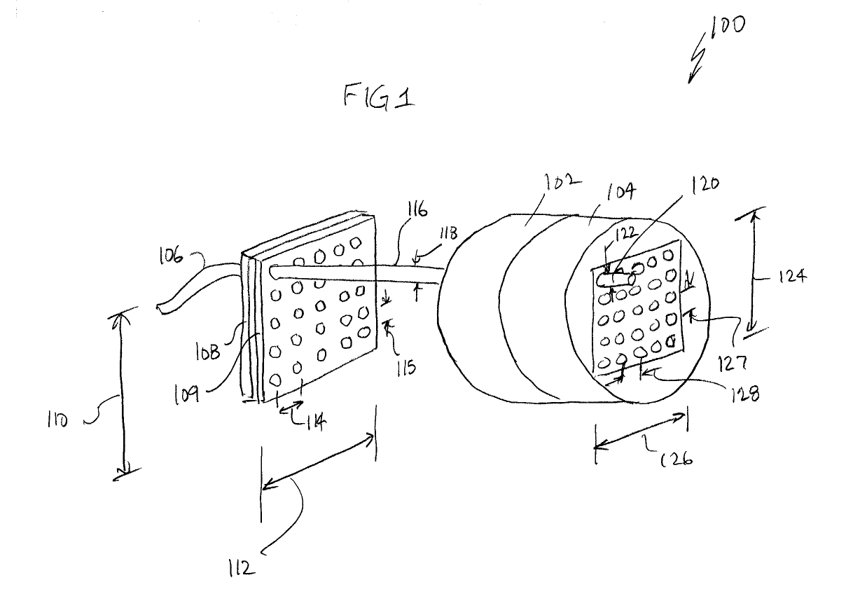

FIG. 1 shows an isometric view of the afocal lens system of the present invention and is generally designated 100. The afocal lens system 100 consists of a first convex/concave lens 102 and a second convex/concave lens 104. A fiber optic cable 106 is shown attached to a ferrule array 108. The ferrule array 108 precisely aligns the fiber optic cable 106 for optical switching applications. Additional fiber optic cables (not shown) are attached to the ferrule array 108, forming an input optical array with dimensions 110 and 112. Each fiber optic cable is located an equal vertical separation distance 115, and an equal horizontal separation distance 114 from each other within the input optical array.

Fiber optic cable 106 produces a light source which passes through a lenslet 109 to form an input collimated light 116 with an input diameter 118, which enters the first convex/concave lens 102 of the afocal lens system 100. The input collimated light 116 passes through the second convex/concave lens 104 of the afocal lens system 100 and becomes output collimated light 120 with an output diameter 122. The output diameter 122 is reduced from the input diameter 118 by the magnification factor of the afocal lens system 100.

The magnification factor of the afocal lens system is a function of the geometry and material selection of the afocal lens system 100. Additionally, the input array with dimensions 110 and 112 is reduced by the same magnification factor of the afocal lens system, forming an output array with dimensions 124 and 126. As shown in FIG. 1, each out beam has a vertical separation distance 127, and an equal horizontal separation distance 128 from each other beam within the output optical array.

It is not necessary that separation distances 114 and 115 are equal. It is to be appreciated that the separation distances 114 and 115 are related to output separation distances 127 and 128 by the magnification factor. Specifically, the relationship between the horizontal distances is determined by the following equation:

$${D}_{128} = \frac{{D}_{114}}{M}$$

where M is the magnification factor. Similarly, the relationship between the vertical distances is determined by the following equation:

$${D}_{127} = \frac{{D}_{115}}{M}$$

where M is the magnification factor.

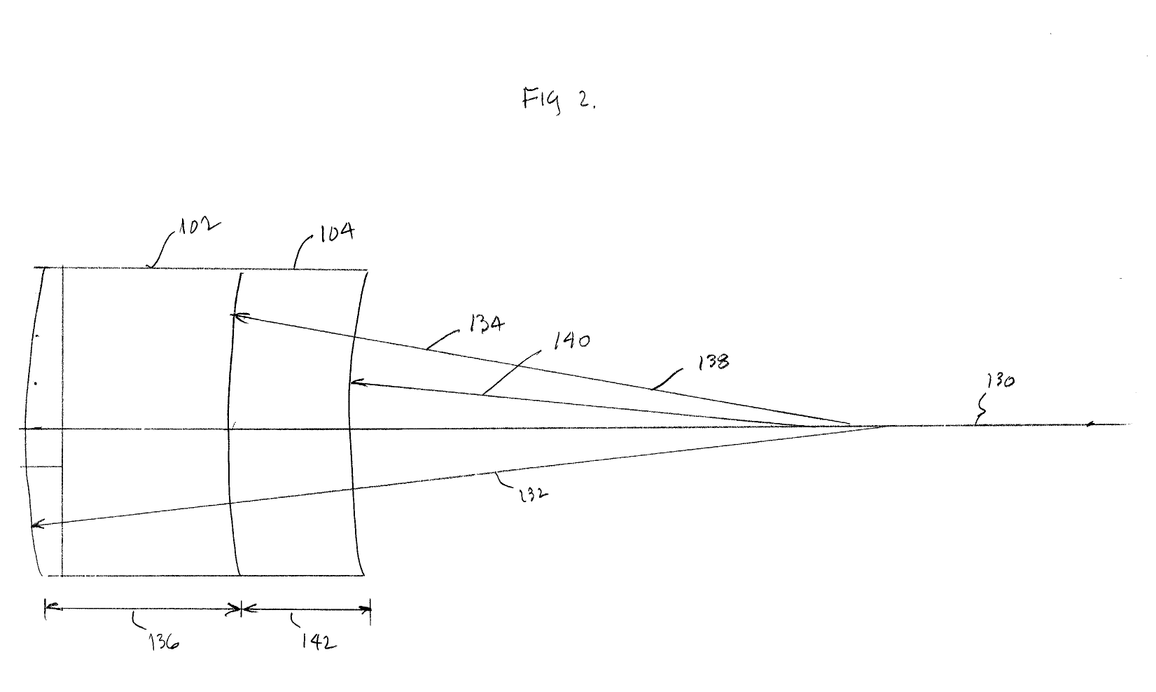

Referring now to FIG. 2, a side view of the afocal lens system 100 is shown with a central optical axis 130. First convex/concave lens 102 is shown with a first convex radius of curvature 132, a first concave radius of curvature 134, and a first lens width 136. Additionally, FIG. 2 shows second convex/concave lens 104 with a convex radius of curvature 138, a concave radius of curvature 140, and a second lens width 142. Note that first concave radius of curvature 134 of first convex/concave lens 102 must equal the second convex radius of curvature 138 of second convex/concave lens 104 in order for the two lenses 102 and 104 to fit together properly.

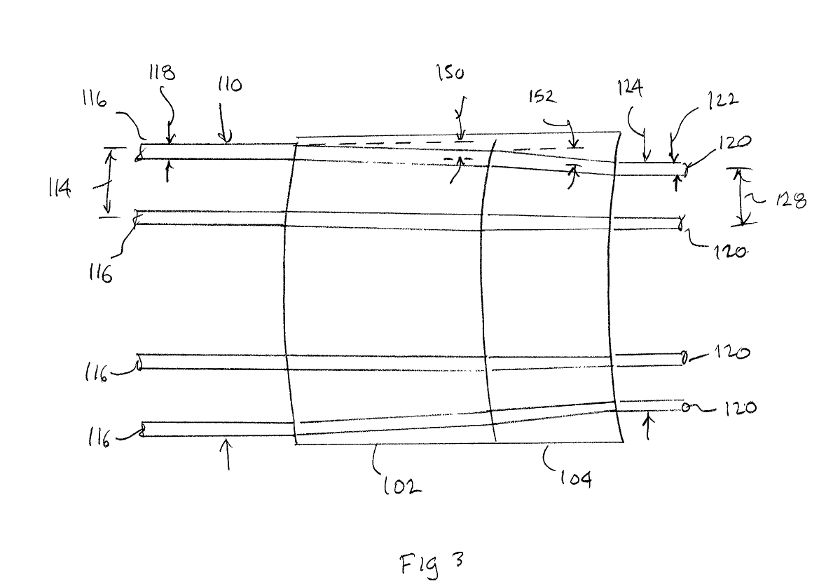

FIG. 3 is a side view of the afocal lens system 100 of the present invention, and shows a ray trace of four (4) collimated light beams as they propagate through the afocal lens system 100. As collimated light 116, with an input diameter 118, strikes the first convex surface of first convex/concave lens 102, the light 116 is refracted a first angle 150 with respect to the initial horizontal position due to the first lens' 102 index of refraction. Additionally, as the collimated light 116 propagates through the second convex/concave lens, it is refracted a second angle 152 with respect to the light beam's 116 path of travel through the first lens 102, due to second lens' 104 different index of refraction. Upon exiting the second concave surface of the second convex/concave lens 104, the input collimated light 116 is reduced by a magnification factor, becoming output collimated light 120 with an output diameter 122. The output collimated light 120 is parallel to the input collimated light 116 beam. A collimated light source 116 is never brought to an intermediate focus as it passes through the afocal lens system 100.

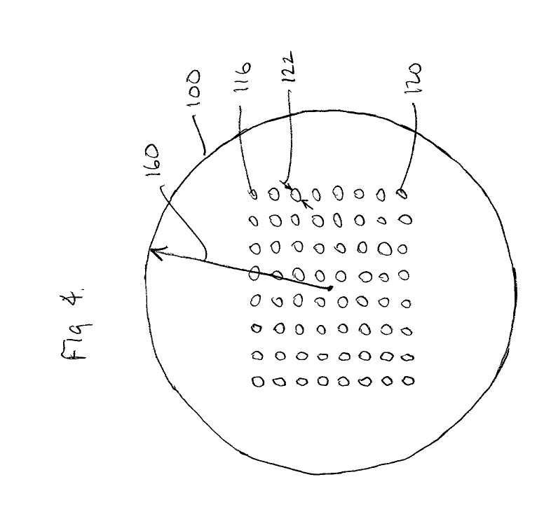

FIG. 4 is an end view of the afocal lens system 100 of the present invention and shows the afocal lens system 100 with an aperture radius 160 and an array of output collimated light 120 beams of reduced output diameter 122.

Referring back to FIG. 2, in order to obtain a 1.128 times magnification factor, first lens 102 may be manufactured with LAKN22 glass. Additionally, first lens 102 may also have a first convex radius of curvature 132 of 18.612-mm, a first concave radius of curvature 134 of 20.33-mm, and a first lens thickness 136 of 3.2-mm. Assuming the specifications for the first lens 102 as set out above, the second lens 104 should be manufactured of SFL6 glass with a second convex radius of curvature 138 of 20.33-mm, a second concave radius of curvature 140 of 16.955-mm, and a second lens thickness 142 of 2.0-mm. These aforementioned specifications for the afocal lens system 100 allow a 1.128 times magnification factor for collimated light of wavelengths between 0.628-microns and 1.55-microns.

While the afocal lens system as herein shown and disclosed in detail is fully capable of obtaining the objects and providing the advantages herein before stated, it is to be understood that it is merely illustrative of a preferred embodiment of the invention and that no limitations are intended to the details of construction or design herein shown other than as described in the appended claims.

I claim:

1. An afocal lens system comprising:
a first lens having a first convex surface with a first convex radius of curvature, a first concave surface with a first concave radius of curvature, and a first lens width; and
a second lens having a second convex surface with a second convex radius of curvature, a second concave surface with a second concave radius of curvature, and a second lens width, wherein said first concave radius of curvature of said first lens is equal to said second convex radius of curvature of said second lens, such that said first concave surface of said first lens may be bonded to said second convex surface of said second lens.

2. The afocal lens system of claim 1 wherein said first lens width of said first lens is 3.20-mm, first convex radius of curvature is 18.612-mm, and first concave radius of curvature is 20.33-mm.

3. The afocal lens system of claim 1 wherein said second lens width of said second lens is 2.00-mm, second convex radius of curvature is 20.33-mm, and second concave radius of curvature is 16.955-mm.

4. The afocal lens system of claim 1 wherein said first lens width of said first lens is 3.20-mm, first convex radius of curvature is 18.612-mm, and first concave radius of curvature is 20.33-mm, and wherein said second lens is made from SFL6 glass having a second lens width of 2.00-mm, a second convex radius of curvature of 20.33-mm, and a second concave radius of curvature of 16.955-mm.

5. The afocal lens system of claim 1 wherein said first lens is made from LAKN22 glass.

6. The afocal lens system of claim 2 wherein said first lens is made from LAKN22 glass.

7. The afocal lens system of claim 4 wherein said first lens is made from LAKN22 glass.

8. The afocal lens system of claim 1 wherein said second lens is made from SFL6 glass.

9. The afocal lens system of claim 3 wherein said second lens is made from SFL6 glass.

10. The afocal lens system of claim 4 wherein said second lens is made from SFL6 glass.
